(19) United States
(12) Patent Application Publication
(10) Pub. No.: US 2009/0048918 A1
(43) Pub. Date: Feb. 19, 2009

(54) ACQUISITION OF AVATAR REWARDS THROUGH ADVERTISEMENT EXPOSURE

(76) Inventors: Christopher J. Dawson, Arlington, VA (US); Rick A. Hamilton, II, Charlottesville, VA (US); Clifford A. Pickover, Yorktown Heights, NY (US); James W. Seaman, Falls Church, VA (US)

Correspondence Address: HOFFMAN WARNICK LLC, 75 STATE ST, 14TH FLOOR, ALBANY, NY, 12207, US

(21) Appl. No.: 11/839,612

(22) Filed: Aug. 16, 2007

(51) Int. Cl. G06Q 30/00

(52) U.S. Cl. 705/14

(57) ABSTRACT

The present invention relates to the acquisition of virtual and/or tangible avatar rewards through advertisement exposure. A method in accordance with an embodiment of the present invention includes: viewing advertising content within the virtual environment; and providing a reward to the avatar for viewing the advertising content.

### FIELD OF THE INVENTION

The present invention relates to advertising, and more specifically relates to the acquisition of virtual and/or tangible avatar rewards through advertisement exposure.

### BACKGROUND OF THE INVENTION

A virtual environment is an interactive simulated environment accessed by multiple users through an online interface. Users inhabit and interact in the virtual environment via avatars. This habitation usually is represented in the form of avatars, which are two or three-dimensional graphical representations of humanoids. There are many different types of virtual environments, however there are several features most virtual environments generally have in common:

A) Shared Space: the world allows many users to participate at once.
B) Graphical User Interface: the environment depicts space visually, ranging in style from 2D “cartoon” imagery to more immersive 3D environments.
C) Immediacy: interaction takes place in real time.
D) Interactivity: the environment allows users to alter, develop, build, or submit customized content.
E) Persistence: the environment's existence continues regardless of whether individual users are logged in.
F) Socialization/Community: the environment allows and encourages the formation of social groups such as teams, guilds, clubs, cliques, housemates, neighborhoods, etc.

An avatar can have a wide range of business and social experiences. Such business and social experiences are becoming more common and increasingly important in on-line virtual environments (e.g., universes, worlds, etc.), such as that provided in the on-line world Second Life (Second Life is a trademark of Linden Research in the United States, other countries, or both). The Second Life client program provides its users (referred to as residents) with tools to view, navigate, and modify the Second Life world and participate in its virtual economy.

Second Life and other on-line virtual environments present a tremendous new outlet for both structured and unstructured virtual collaboration, gaming and exploration, as well as real-life simulations in virtual spaces. These activities, along with yet to be disclosed new dimensions, in turn provide a wide open arena for creative and new advertising methods and mechanisms. Unfortunately, existing advertising methods and mechanisms generally have a high nuisance factor and are widely disliked by users. Accordingly, there exists a need for a solution to address these and other deficiencies of the related art.

### SUMMARY OF THE INVENTION

The present invention provides virtual and/or tangible rewards to avatars based on the viewing of advertisements within a virtual environment. The rewards may be virtual resources useable by the avatar in the virtual environment, and/or physical resources available to the end-user controlling the avatar. Avatars viewing more advertisements can acquire more rewards. This motivates avatars to view advertisements in a virtual environment. In accordance with the present invention, the phrase “virtual environment” comprises any and all virtual spaces or locations, such as universes, worlds, countries, cities, buildings, etc., in which a user's avatar exists and interacts.

A first aspect of the present invention is directed to a method for providing rewards to an avatar, comprising: viewing advertising content within the virtual environment; and providing a reward to the avatar for viewing the advertising content.

A second aspect of the present invention is directed to a system for providing rewards to an avatar, comprising: a system for viewing advertising content within the virtual environment; and a system for providing a reward to the avatar for viewing the advertising content.

A third aspect of the present invention is directed to a program product stored on a computer readable medium, which when executed, provides rewards to an avatar, the computer readable medium comprising program code for: viewing advertising content within the virtual environment; and providing a reward to the avatar for viewing the advertising content.

A fourth aspect of the present invention is directed to a method for deploying an application for providing rewards to an avatar, comprising: providing a computer infrastructure being operable to: view advertising content within the virtual environment; and provide a reward to the avatar for viewing the advertising content.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 is an illustrative hybrid system/process diagram depicting the acquisition of rewards in a virtual environment in accordance with an embodiment of the present invention.

FIG. 2 depicts the depositing of a reward in accordance with an embodiment of the present invention.

FIG. 3 depicts the mirroring of a reward between a virtual environment and the real world in accordance with an embodiment of the present invention.

FIG. 4 is an illustrative hybrid system/process diagram in accordance with various embodiments of the present invention.

FIG. 5 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention relates to the acquisition of virtual and/or tangible avatar rewards through advertisement exposure.

Virtual environments provide a new and potentially mutually beneficial advertising medium for both the consumer and companies sponsoring advertisements. The present invention discloses a mutually beneficial advertising method in which avatars are given rewards to view advertisements within a virtual environment.

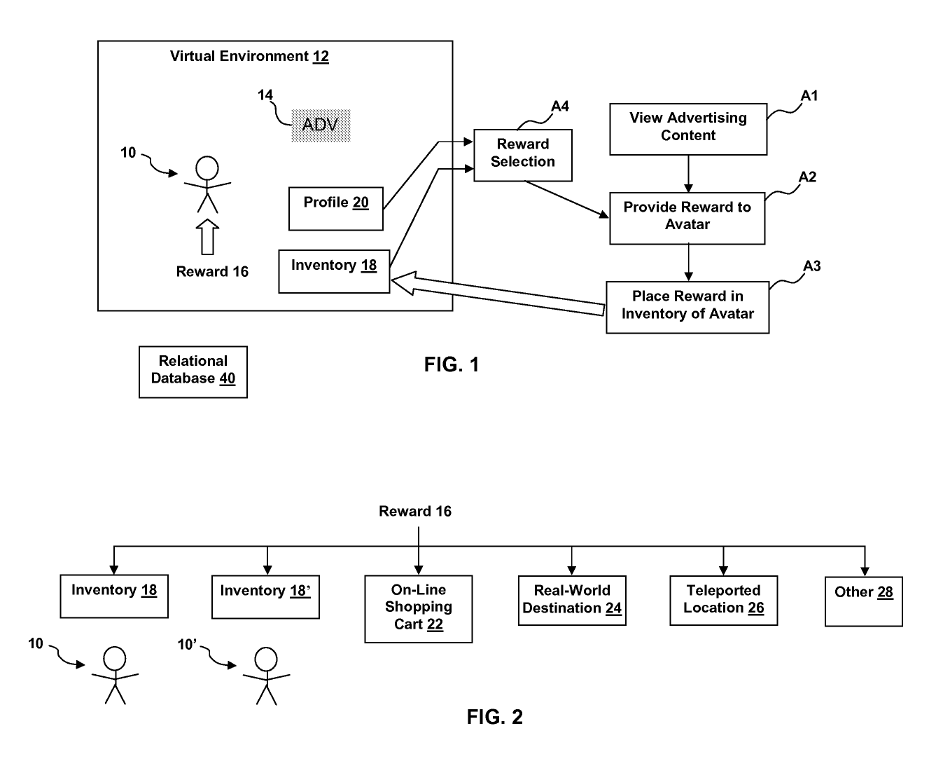

In accordance with an embodiment of the present invention, as depicted in FIG. 1, when an avatar 10 in a virtual environment 12 views (A1) advertising content 14, the avatar 10 is provided (A2) with a reward 16. Such viewing can be active or user-prompted (e.g., by clicking on or otherwise actuating an advertisement), or may be passive (e.g., by entering a location where a sponsor's logo or advertisement is located).

As an example, when a user clicks on the advertising content 14, the user's avatar 10 is given a reward 16, which is placed (A3) in the inventory 18 of the avatar 10. The reward 16 can be automatically placed in the inventory 18 of the avatar 10. Alternatively, the avatar 10 can be presented with the reward 16 and can decide to accept/decline the reward 10. If the reward 16 is accepted, it is then placed in the in the inventory 18 of the avatar 10.

The reward 16 can be selected (A4) based on the stated interests of the avatar 10 (e.g., as provided in a profile 20 of the avatar 10), can be general in nature, and/or can be based on other criteria. The same or a different reward 16 can be provided to each avatar 10 that views a given advertising content 14. The reward 16 can be predetermined or can be chosen randomly. A reward 16 can be selected from among a group of available rewards 16. Many other reward selection scenarios are also possible. Pictures and/or other indicators of the type of available rewards 16 can be displayed in conjunction with the advertising content 14.

The reward 16 can comprise, for example, virtual items such as new avatar hairpieces, programs, gestures, clothes, buildings, companions, artwork, pets, etc. The reward 16 can also comprise an increase in the rank of an avatar 10 within the virtual environment 12. The type of reward 16 is practically boundless. The precise nature of the reward 16 can be determined, for example, by an automatic analysis of the items already present in the inventory 18 of the avatar 10. For instance, if an analysis of the inventory 18 of the avatar 10 determines that golf clubs are present in the inventory 18, golf balls may be added to the inventory 18 as the reward 16. If an analysis of the inventory 18 of the avatar 10 determines that the avatar 10 has a certain brand of shoes in the inventory 18, a different brand of virtual shoes or a related clothing item of the same brand can be added to the inventory as the reward 16.

The reward 16 can be deposited in the inventory 18 of the avatar 10 as depicted in FIG. 1. As further depicted in FIG. 2, the reward 16 can be deposited in the inventory 18′ of another avatar 10′, a real-world on-line shopping cart 22, or a real-world destination 24 (e.g., a coupon sent to a real-world address). The reward 16 can also be “teleported” to a different region or location 26 in the virtual environment 12 and left there for friends or strangers to take (e.g., as a charitable gift). Other depositories/locations 28 for the reward 16 are also possible.

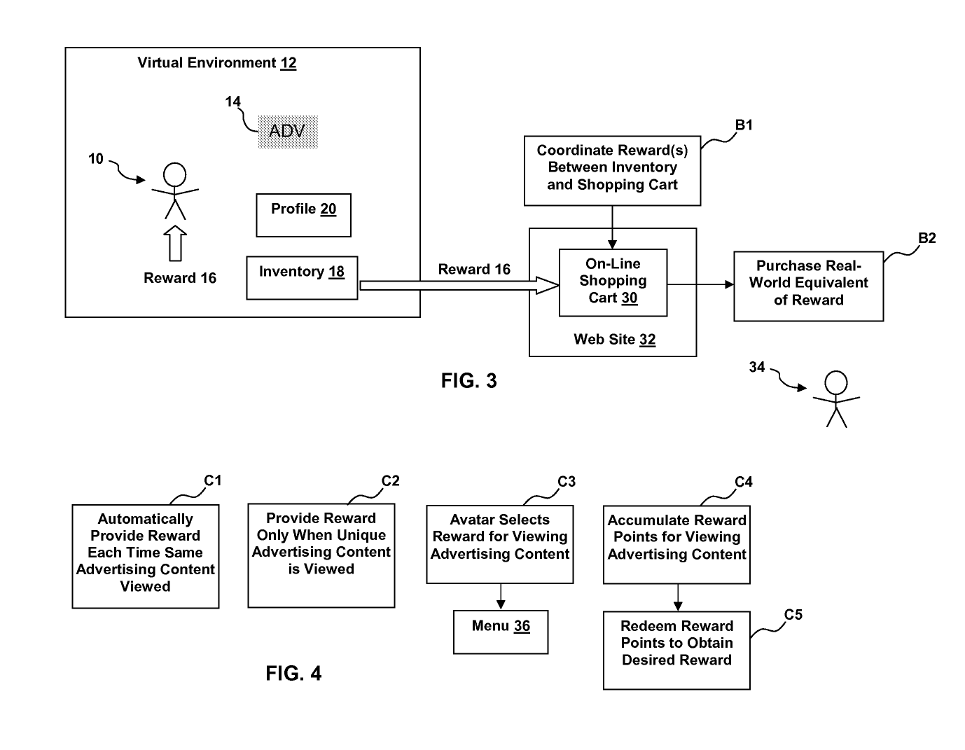

As depicted in FIG. 3, coordination (B1) of the inventory 18 of an avatar 10 can be provided such that at least one reward 16 in the inventory 18 is mirrored in a shopping cart 30 of a web site 32, for potential purchase in the real world. This would allow the end-user 34 controlling the avatar 10 to purchase (B2) a real-world equivalent of a reward 16. For example, if a reward 16 comprising a virtual pair of sneakers of a particular brand has been deposited in the inventory 18 of the avatar 10 in response to the viewing of corresponding advertising content 14, the reward 16 can also be placed in the shopping cart 30 of a predetermined shopping web site 32 for potential purchase by the end-user 34 controlling the avatar 10.

Various reward-related embodiments of the present invention are depicted in FIG. 4. In one embodiment of the present invention, a reward 16 is automatically provided (C1) to an avatar 10 each time the same corresponding advertising content 14 is viewed. In this case, the same or a different reward 16 can be provided each time the corresponding advertising content 14 is viewed. In another embodiment, a reward 16 is provided (C2) only upon viewing unique advertising content 14 (i.e., no reward 16 for repeat viewings of the same advertising content 14). In yet another embodiment, the avatar 10 can select (C3) from among available rewards 16. This can be provided via a menu 36 or other selection mechanism. In a further embodiment, rewards 16 can have point values and the avatar 10 can accumulate reward points (C4) by viewing advertising content 14 and can redeem (C5) the points to obtain a desired reward 10. The point values can be virtual, for use in the virtual environment 12, or can be redeemable in a real-world transaction (e.g., credit card points, frequent flier points, shopping points, coupons, etc.).

A reward 16 can be contextual and relevant to a current environment of the avatar 10 within the virtual environment 12. As an example, an avatar 10 viewing advertising content 14 in a virtual bookstore may receive a discount coupon for a book store as a reward 16. Of course, a reward 16 can be general and not associated with the current environment.

An avatar 10 can earn a reward 16 by hosting the advertising content 14 of a sponsor. Such hosting may include, for instance, superimposing the advertising content 14 or associated trigger on a virtual building, a virtual sign, a virtual landscape, other virtual objects, on the avatar 10 itself, etc. Advertising content 14 can be displayed as a “watermark” superimposed on buildings, landscapes, avatars 10, or other suitable locations. The transparency of the watermark can be used to indicate the level of the associated reward 16. For example, a barely visible watermark can be used to indicate a smaller reward than a more visible (e.g., more opaque) watermark.

As depicted in FIG. 1, a relational database 40 can be used to store information regarding avatars 10 and their associated rewards 16 (and points). This provides a mechanism for quick and easy addition, redemption, and transfer of rewards 16 (and points). Based on the display method chosen, whether it is via a link to the inventory 18 of an avatar 10, or via an independent function to view rewards 16, use of the relational database 40 provides the flexibility and ease of implementation to support the present invention. Using the relational database 40 with now known or later developed client query methods such as SQL, also provides the avatar/end-user with real-time access to custom views of the rewards 16 (and points) accumulated and available. Of course, other suitable data management methodologies can also be used to implement the present invention.

Examples of the rewards 16 that can be provided include, but are not limited to, the following:

Virtual real estate

Virtual structures (e.g., house, building, etc.)

Virtual pets

Virtual companions

Virtual wardrobes

Virtual artwork

Virtual skills, gestures, or abilities

Reward points (virtual and real-world)

Avatar rank

Physical (tangible) gifts, coupons, discounts, etc.

Permanent or temporary ad sponsorship of virtual space or structure

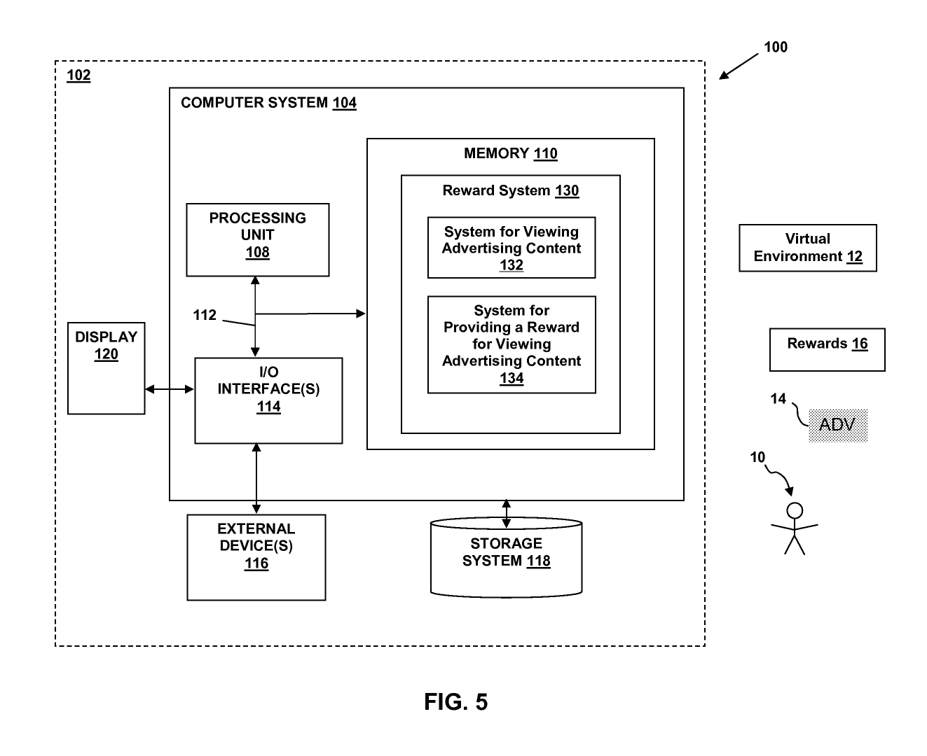

FIG. 5 depicts an illustrative system 100 for the acquisition, by an avatar 10, of virtual and/or tangible (e.g., real-world) rewards 16 in a virtual environment 12 through exposure to advertising content 14, in accordance with any/all embodiments of the present invention. The system 100 includes a computer infrastructure 102 that can perform the various processes described herein. The computer infrastructure 102 is shown including a computer system 104.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, such as a reward system 130, that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device (e.g., display 120) that enables a user to interact with the computer system 104 or any device that enables the computer system 104 to communicate with one or more other computer systems.

The reward system 130 is configured to implement any/all embodiments of the of the present invention, as detailed above. For example, the reward system 130 can comprise a system 132 for viewing advertising content 14 within the virtual environment 12 and a system 134 for providing a reward 16 to an avatar 10 for viewing the advertising content 14.

The computer system 104 can comprise any general purpose computing article of manufacture capable of executing computer program code installed by a user (e.g., a personal computer, server, handheld device, etc.). However, it is understood that the computer system 104 is only representative of various possible computer systems that may perform the various processes of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in an embodiment, the computer infrastructure 102 comprises two or more computer systems (e.g., a server cluster) that communicate over any type of wired and/or wireless communications link, such as a network, a shared memory, or the like, to perform the various processes of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

It is understood that some of the various systems shown in FIG. 4 can be implemented independently, combined, and/or stored in memory for one or more separate computer systems that communicate over a network. Further, it is understood that some of the systems and/or functionality may not be implemented, or additional systems and/or functionality may be included as part of the system 100.

It is understood that the invention further provides various alternative embodiments. For example, in an embodiment, the invention provides a computer-readable medium that includes computer program code to enable a computer infrastructure to carry out and/or implement the various processes of the present invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the processes of the invention on a subscription, advertising, and/or fee basis. A service provider can create, maintain, support, etc., a computer infrastructure, such as the computer infrastructure 102, that performs the processes of the invention for one or more customers. In return, the service provider can receive payment from the customer(s) under a subscription and/or fee agreement and/or the service provider can receive payment from the sale of advertising space to one or more third parties.

In still another embodiment, a computer infrastructure, such as the computer infrastructure 102, can be obtained (e.g., created, maintained, having made available to, etc.) and one or more systems for performing the processes of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the processes of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. The program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for providing rewards to an avatar, comprising:
viewing advertising content within the virtual environment; and
providing a reward to the avatar for viewing the advertising content.

2. The method of claim 1, wherein the viewing of advertising content is selected from the group consisting of actively viewing the advertising content and passively viewing the advertising content.

3. The method of claim 1, wherein the reward is selected from the group consisting of a virtual reward usable in the virtual environment and a tangible reward usable by an end-user controlling the avatar.

4. The method of claim 1, further comprising:
depositing the reward in an inventory of the avatar.

5. The method of claim 1, further comprising:
presenting the award to the avatar for acceptance; and
depositing the reward in an inventory of the avatar upon acceptance of the award by the avatar.

6. The method of claim 1, further comprising:
selecting the reward based on at least one of an interest of the avatar and items already present in an inventory of the avatar.

7. The method of claim 1, wherein the reward is selected from the group consisting of a predetermined reward and a randomly chosen reward.

8. The method of claim 1, further comprising:
depositing the reward in an on-line shopping cart for purchase by an end-user controlling the avatar.

9. The method of claim 1, further comprising:
teleporting the reward to a location within the virtual environment.

10. The method of claim 1, further comprising:
sending the reward to a real-world location.

11. The method of claim 1, wherein providing a reward to the avatar for viewing the advertising content is selected from the group consisting of:
providing the reward to the avatar a single time, regardless of a number of times the avatar views the advertising content;
providing the same reward to the avatar each time avatar views the advertising content;
providing a different reward to the avatar each time avatar views the advertising content; and
providing a menu to the avatar, wherein the avatar can select the reward from the menu.

12. The method of claim 1, wherein the reward comprises a number of points;
and wherein the avatar can redeem the points to obtain a desired virtual or real-world reward.

13. The method of claim 1, wherein the reward is contextual and relevant to a current environment of the avatar.

14. The method of claim 1, wherein the avatar can host advertising content of a sponsor.

15. A system for providing rewards to an avatar, comprising:
a system for viewing advertising content within the virtual environment; and
a system for providing a reward to the avatar for viewing the advertising content.

16. The system of claim 15, wherein the system for viewing advertising content is selected from the group consisting of a system for actively viewing the advertising content and a system for passively viewing the advertising content.

17. The system of claim 15, wherein the reward is selected from the group consisting of a virtual reward usable in the virtual environment and a tangible reward usable by an end-user controlling the avatar.

18. The system of claim 15, further comprising:
a system for depositing the reward in an inventory of the avatar.

19. The system of claim 15, further comprising:
a system for presenting the award to the avatar for acceptance; and
a system for depositing the reward in an inventory of the avatar upon acceptance of the award by the avatar.

20. The system of claim 15, further comprising:
a system for selecting the reward based on at least one of an interest of the avatar and items already present in an inventory of the avatar;
wherein the reward is selected from the group consisting of a predetermined reward and a randomly chosen reward.

21. The system of claim 15, further comprising:
a system for depositing the reward in an on-line shopping cart for purchase by an end-user controlling the avatar.

22. The system of claim 15, further comprising:
a system for teleporting the reward to a location within the virtual environment.

23. The system of claim 15, further comprising:
a system for sending the reward to a real-world location.

24. The system of claim 15, wherein the system for providing a reward to the avatar for viewing the advertising content is selected from the group consisting of:
a system for providing the reward to the avatar a single time, regardless of a number of times the avatar views the advertising content;
a system for providing the same reward to the avatar each time avatar views the advertising content;
a system for providing a different reward to the avatar each time avatar views the advertising content; and
a system for providing a menu to the avatar, wherein the avatar can select the reward from the menu.

25. The system of claim 15, wherein the reward comprises a number of points, the system further comprising:
a system for redeeming the points to obtain a desired virtual or real-world reward.

26. The system of claim 15, wherein the reward is contextual and relevant to a current environment of the avatar.

27. The system of claim 15, further comprising:
a system for allowing the avatar to host advertising content of a sponsor.

28. A program product stored on a computer readable medium, which when executed, provides rewards to an avatar, the computer readable medium comprising program code for:
viewing advertising content within the virtual environment; and
providing a reward to the avatar for viewing the advertising content.

29. A method for deploying an application for providing rewards to an avatar, comprising:
providing a computer infrastructure being operable to:
view advertising content within the virtual environment; and
provide a reward to the avatar for viewing the advertising content.

29. A method for deploying an application for providing rewards to an avatar, comprising:
providing a computer infrastructure being operable to:
view advertising content within the virtual environment; and
provide a reward to the avatar for viewing the advertising content
